(19) United States
(12) Patent Application Publication
(10) Pub. No.: US 2025/0360733 A1
(43) Pub. Date: Nov. 27, 2025

(54) BUTTON PRODUCT FABRICATING DEVICE

(71) Applicant: Brother Kogyo Kabushiki Kaisha, Nagoya (JP)

(72) Inventors: Yuji Koga, Nagoya (JP); Kenji Takeuchi, Nagoya (JP); Yoji Tsujishita, Ichinomiya-shi (JP)

(21) Appl. No.: 19/291,583

(22) Filed: Aug. 5, 2025

Related U.S. Application Data
(63) Continuation of application No. PCT/JP2024/003453, filed on Feb. 2, 2024.

(30) Foreign Application Priority Data
Feb. 6, 2023 (JP) 2023-016324

(51) Int. Cl. B41J 13/03; B30B 15/02; B41J 3/44; B41J 11/00; B41J 29/393

(52) U.S. Cl. CPC B41J 13/03; B30B 15/02; B41J 3/445; B41J 11/0015; B41J 29/393

(57) ABSTRACT

A button product fabricating device is configured to fabricate a button product by connecting a front member and a back member. The button product fabricating device includes: a printer configured to perform printing on a printing medium; a die set configured to connect the front member and the back member; and a conveyor configured to convey the printing medium onto the front member along a conveying path from the printer toward the die set. The conveyor includes: a plurality of conveying rollers; and a one-way clutch. The one-way clutch is configured to: transmit a drive force to the conveying rollers when rotating in a first rotation direction; and not to transmit the drive force to the conveying rollers when rotating in a second rotation direction which is a direction opposite to the first rotation direction.

### REFERENCE TO RELATED APPLICATIONS

This is a continuation of International Application No. PCT/JP2024/003453 filed on Feb. 2, 2024, and claims priority from Japanese Patent Application No. 2023-016324 filed on Feb. 6, 2023. The entire contents of the aforementioned applications are incorporated herein by reference.

### BACKGROUND ART

The present disclosure relates to a button product fabricating device.

As an example of a device for fabricating a button product such as a button badge to which a predetermined image is applied a button product fabricating device fabricates a button badge by crimping a front lid to a back lid.

### DESCRIPTION

However, in the above button product fabricating device, a user himself or herself places, on a film placement surface of the lower die, a transparent film for crimping together with the front lid to the back lid supported by a lower die. Therefore, the user himself or herself can enjoy the fabrication of the button badge by participating in the fabrication of the button badge, but there is a problem that a time until the completion of the fabrication of the button badge becomes long.

Therefore, an object of the present disclosure is to provide a button product fabricating device capable of shortening a button product fabricating time.

A button product fabricating device according to the present disclosure is configured to fabricate a button product by connecting a front member and a back member, and the button product fabricating device includes: a printer configured to perform printing on a printing medium; a die set configured to connect the front member and the back member; and a conveyor configured to convey the printing medium onto the front member along a conveying path from the printer toward the die set. The conveyor includes: a plurality of conveying rollers; and a one-way clutch, and the one-way clutch is configured to: transmit a drive force to the conveying rollers when rotating in a first rotation direction; and not to transmit the drive force to the conveying rollers when rotating in a second rotation direction which is a direction opposite to the first rotation direction.

According to the present disclosure, the printing medium is conveyed by the conveyor onto the front member supported by a lower die. Accordingly, a time required for disposing the printing medium onto the front member is shortened, and thus the button product fabricating time can be shortened as a whole. In addition, when the conveying path is divided into a first conveying path and a second conveying path different from the first conveying path, an unnecessary portion of the printing medium can be discarded along the second conveying path by rotating the conveying rollers in a predetermined direction. In this case, by providing the one-way clutch to the conveying rollers that clamp another printing medium in the first conveying path, no drive force is transmitted to the conveying rollers in the first conveying path during conveying in the second conveying path. Accordingly, the other printing medium can be made to wait in the first conveying path. Therefore, the printing medium can be quickly conveyed to the die set.

According to the present disclosure, it is possible to provide a button product fabricating device capable of shortening a button product fabricating time.

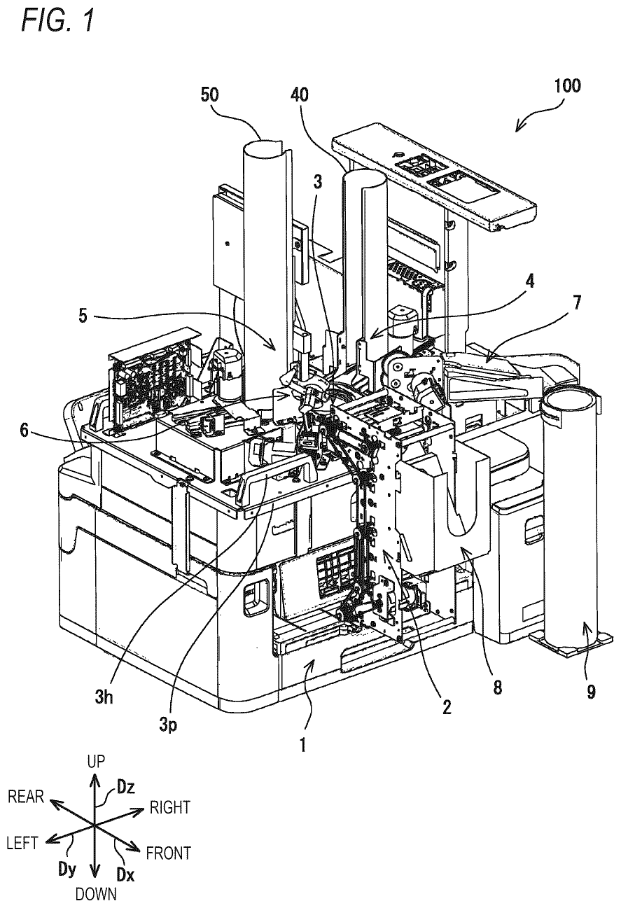

FIG. 1 is a perspective view illustrating a button product fabricating device according to the present embodiment.

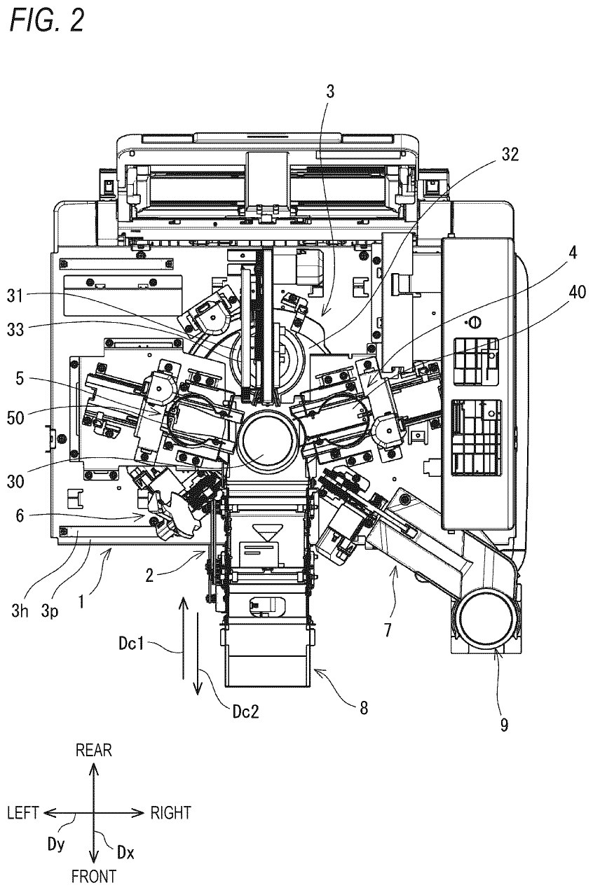

FIG. 2 is a plan view of the button product fabricating device in FIG. 1.

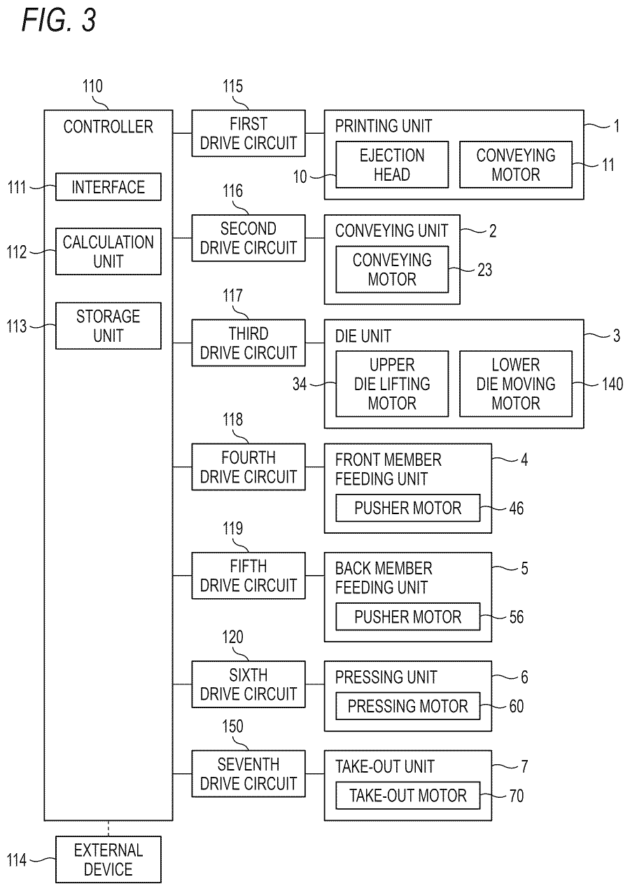

FIG. 3 is a block diagram illustrating a configuration of a control system of the button product fabricating device in FIG. 1.

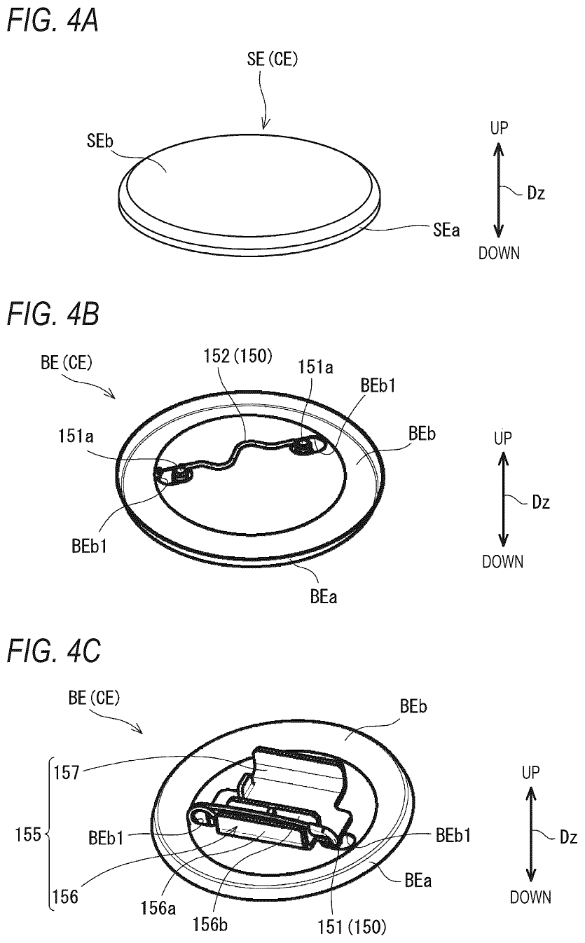

FIG. 4A is a perspective view illustrating a front member.

FIG. 4B is a perspective view of a back member as viewed from a front side.

FIG. 4C is a perspective view of the back member as viewed from a back side.

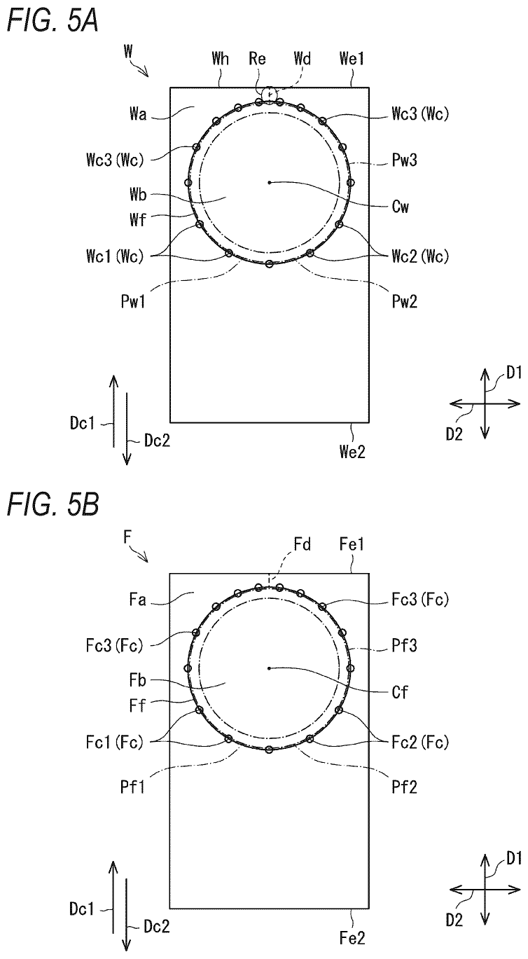

FIG. 5A is a plan view illustrating a printing medium.

FIG. 5B is a plan view illustrating a white film.

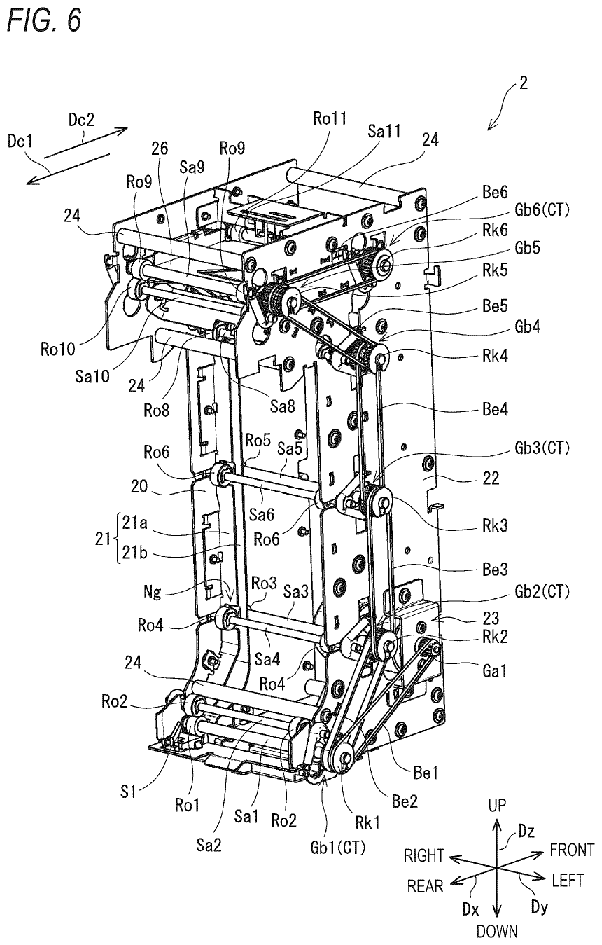

FIG. 6 is a perspective view illustrating a conveying unit.

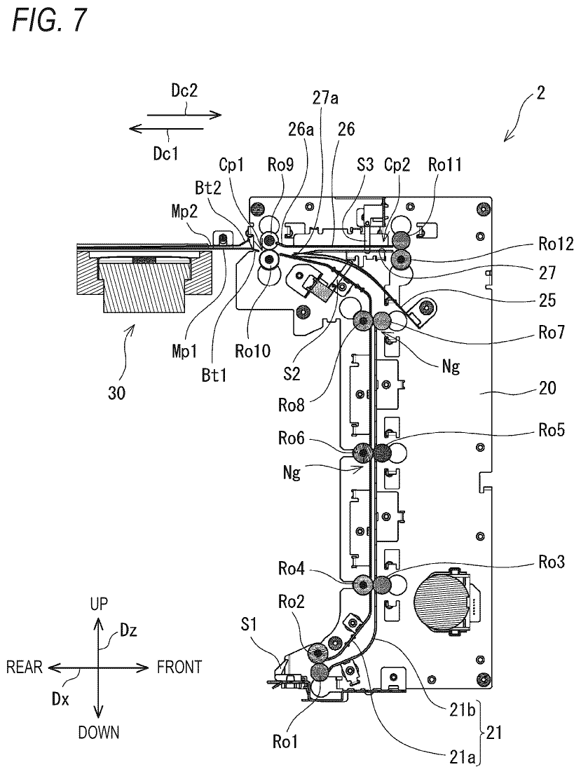

FIG. 7 is a side view of the conveying unit in FIG. 6.

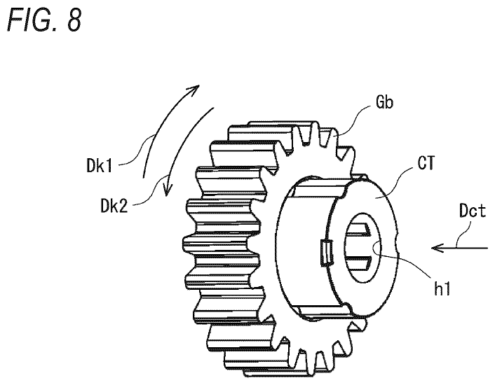

FIG. 8 is a perspective view of a one-way clutch.

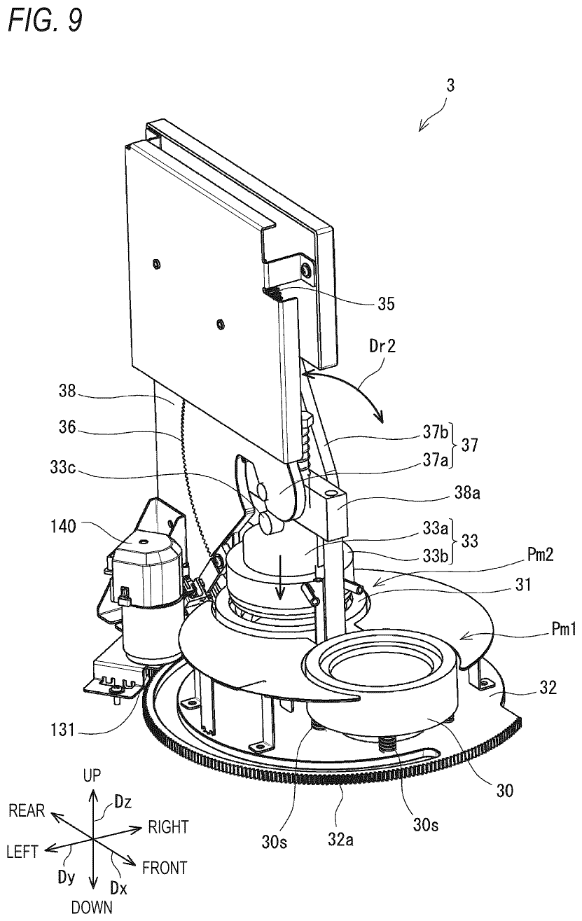

FIG. 9 is a perspective view of a die unit.

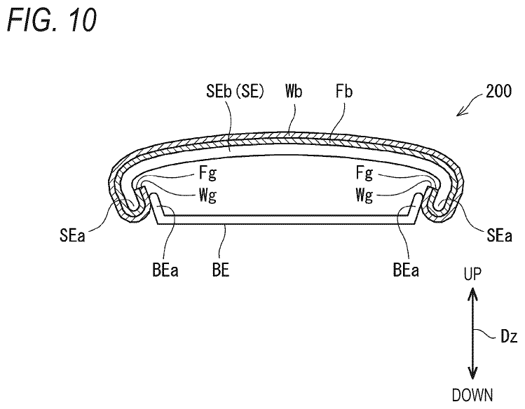

FIG. 10 is a cross-sectional view of a button product fabricated by crimping the front member and the back member.

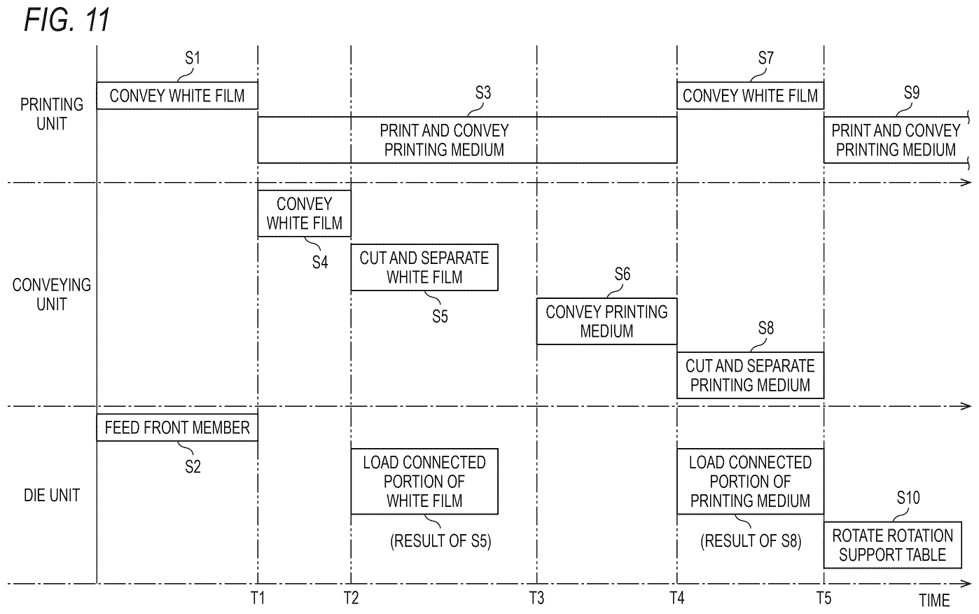

FIG. 11 is a diagram illustrating a time chart related to a process of a printing unit, the conveying unit, and the die unit.

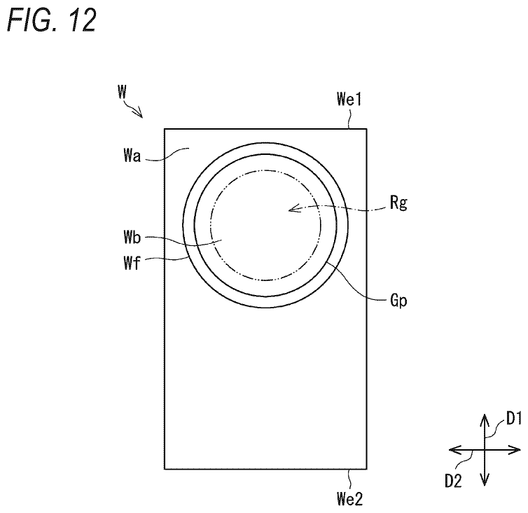

FIG. 12 is a plan view illustrating a modification of a printing medium W.

Hereinafter, a button product fabricating device according to an embodiment of the present disclosure will be described with reference to the drawings. The button product fabricating device to be described later is merely an embodiment of the present disclosure. Accordingly, the present disclosure is not limited to the following embodiment, and can be added, deleted, or modified without departing from the scope of the present disclosure.

### (Overall Configuration of Button Product Fabricating Device)

FIG. 1 is a perspective view illustrating a button product fabricating device 100 according to an embodiment of the present disclosure. FIG. 2 is a plan view of the button product fabricating device 100 in FIG. 1. FIG. 3 is a block diagram illustrating a configuration of a control system of the button product fabricating device 100 in FIG. 1.

The button product fabricating device 100 is a device that fabricates a button product by connecting a front member and a back member as a button member. Specifically, the button product fabricating device 100 fabricates a button product by crimping the front member and the back member. As illustrated in FIGS. 1 and 2, the button product fabricating device 100 includes a printing unit 1, a conveying unit 2, a die unit 3, a front member feeding unit 4, a back member feeding unit 5, a pressing unit 6, a take-out unit 7, a collection box 8, and a button product container 9. In FIGS. 1 and 2, directions orthogonal to one another are referred to as a first direction Dx, a second direction Dy, and a third direction Dz. In the present embodiment, for example, the first direction Dx is a front-rear direction of the button product fabricating device 100, the second direction Dy is a left-right direction of the button product fabricating device 100, and the third direction Dz is an up-down direction. In this case, a front side of the printing unit 1 is referred to as a front side, a rear side thereof is referred to as a rear side, and left and right sides thereof as viewed from the front side are referred to as a left side and a right side. In the following description, Dx is referred to as the front-rear direction, Dy is referred to as the left-right direction, and Dz is referred to as the up-down direction. The printing unit 1 serves as an example of a printer, a conveying unit 2 serves as an example of a conveyor, and a die unit 3 serves as an example of a die set.

The printing unit 1 is disposed below the die unit 3, the front member feeding unit 4, the back member feeding unit 5, the pressing unit 6, and the take-out unit 7. The printing unit 1 is grounded. An installation area of the printing unit 1 is equal to or larger than an installation area of the die unit 3. The printing unit 1 is an inkjet printer that prints an image on a printing medium W (FIG. 5A to be described later) such as a transparent film. The printing unit 1 performs printing on the printing medium W. The printing unit 1 includes an ejection head 10 that ejects ink droplets onto the printing medium W and a conveying motor 11 that drives a conveying roller. The ejection head 10 may be a serial head type or a line head type.

The printing unit 1 includes a sheet holder (not illustrated) that holds a plurality of printing media W and a plurality of white films F (FIG. 5B to be described later), and the printing media W and the white films F are held on the sheet holder as a bundle in which the printing media W and the white films F are alternately stacked. A concept including the printing medium W and the white film F is referred to as a sheet. The white film F is fed to the conveying unit 2 without being printed by the printing unit 1, and the printing medium Wis fed to the conveying unit 2 after a predetermined image is printed by the ejection head 10 of the printing unit 1. The predetermined image is an inverted image that becomes a normal image when a user views the image from a surface opposite to a surface on which the image is printed among the surfaces of the printing medium W. In the present embodiment, an example in which the printing unit 1 is an inkjet printer has been described, but the printing unit 1 is not limited thereto, and may be another printer such as a laser printer or a thermal printer.

Regarding the conveying unit 2, a part of the conveying unit 2 is disposed in front of the printing unit 1, and the entire conveying unit 2 is disposed in front of the die unit 3. At least a part of the conveying unit 2 is disposed on a lateral side of the printing unit 1. In the present embodiment, a part of the conveying unit 2 is disposed in front of the printing unit 1. At least a part of the conveying unit 2 straddles the lateral side of the printing unit 1 and a lateral side of the die unit 3. That is, at least a part of the conveying unit 2 is disposed over the front of the printing unit 1 and the front of the die unit 3. The conveying unit 2 conveys, along a conveying direction Dc1, the printing medium W and the white film F conveyed from the printing unit 1 onto a front member SE (FIG. 4A) provided in a button member CE to be described later which is fed in advance to a lower die 30 provided in the die unit 3.

The die unit 3 connects the front member SE and a back member BE (FIGS. 4B and 4C) to be described later which is provided in the button member CE. Specifically, the die unit 3 crimps the front member SE and the back member BE. The die unit 3 is disposed above the printing unit 1. Such a die unit 3 includes the lower die 30, a lower die 31, a rotation support table 32, an upper die 33, an upper die lifting motor 34, a lower die moving motor 140, a base plate 3p, and a handle 3h. The base plate 3p of the die unit 3 has a flat plate shape and is disposed on the printing unit 1. The handle 3h is to be held by the user. The handle 3h has a substantially U shape and is provided on the base plate 3p. The handle 3h is disposed in front of and to the left of the base plate 3p. The lower die 30 and the lower die 31 are formed in a circular shape in a plan view, and are supported by the rotation support table 32. The lower die 30 and the lower die 31 face each other with a center of the rotation support table 32 as a reference. The upper die 33 moves up and down to approach or separate from either the lower die 30 or the lower die 31 in the up-down direction Dz based on an operation of the upper die lifting motor 34.

The rotation support table 32 pivots around the up-down direction Dz based on an operation of the lower die moving motor 140. By pivoting the rotation support table 32, either the lower die 30 or the lower die 31 can be positioned at a second die position Pm2 (FIG. 9 to be described later), which is a position facing the upper die 33 in the up-down direction Dz. A position facing the second die position Pm2 in the front-rear direction Dx is referred to as a first die position Pm1 (FIG. 9 to be described later). When the lower die 30 is at the first die position Pm1, the front member SE is fed to the lower die 30 by the front member feeding unit 4. Accordingly, the lower die 30 supports the front member SE. After the white film F is conveyed onto the front member SE by the conveying unit 2, a first separation process to be described later is performed. Accordingly, only a later-described connected portion Fb of the white film F is disposed on the front member SE. Subsequently, after the printing medium W is conveyed onto the connected portion Fb on the front member SE by the conveying unit 2, a second separation process to be described later is performed. Accordingly, only a later-described connected portion Wb of the printing medium Wis disposed on the connected portion Fb.

Next, the lower die 30 at the first die position Pm1 while supporting the front member SE is positioned at the second die position Pm2 by pivoting the rotation support table 32. At this time, the lower die 31 at the second die position Pm2 moves to the first die position Pm1. Then, the upper die 33 is lowered, and the front member SE supported by the lower die 30 is held by the upper die 33. Thereafter, the upper die 33 is raised, and the front member SE is separated from the lower die 30 by the upper die 33. At this time, the back member BE is fed to the lower die 31 by the back member feeding unit 5. Subsequently, the lower die 31 at the first die position Pm1 is positioned at the second die position Pm2 by pivoting the rotation support table 32. Thereafter, the upper die 33 holding the front member SE is lowered toward the lower die 31 supporting the back member BE, so that the back member BE is crimped to the front member SE. In this way, the die unit 3 fabricates a button product 200 (FIG. 10 to be described later) by crimping the back member BE held by the lower die 31 and the front member SE held by the upper die 31. Thereafter, the lower die 31 at the second die position Pm2 is positioned at the first die position Pm1 by pivoting the rotation support table 32. Then, the button product 200 supported by the lower die 31 moved to the first die position Pm1 is taken out by the take-out unit 7.

The front member feeding unit 4 is disposed above the printing unit 1 and to the right of the die unit 3. The front member feeding unit 4 includes a front member stocker 40 and a pusher motor 46. The front member stocker 40 accommodates the front member SE in a state of being stacked in a height direction. The front member feeding unit 4 feeds the front member SE to the lower die 30 by a pusher pushing out the front member SE based on an operation of the pusher motor 46.

The back member feeding unit 5 is disposed above the printing unit 1 and to the left of the die unit 3. The back member feeding unit 5 includes a back member stocker 50 and a pusher motor 56. The back member stocker 50 accommodates the back member BE in a state of being stacked in the height direction. A height of the back member stocker 50 is larger than a height of the front member stocker 40. The back member feeding unit 5 feeds the back member BE to the lower die 31 by a pusher pushing out the back member BE based on an operation of the pusher motor 56.

The pressing unit 6 is disposed in front of the front member feeding unit 4 and the back member feeding unit 5 and to the left of the die unit 3. The pressing unit 6 includes a pressing motor 60. The pressing unit 6 presses the printing medium W and the white film F toward the lower die 30 based on an operation of the pressing motor 60.

The take-out unit 7 is disposed in front of the front member feeding unit 4. The take-out unit 7 includes a take-out motor 70. The take-out unit 7 takes out the button product 200 from the lower die 31 based on an operation of the take-out motor 70, and guides the button product 200 to the button product container 9 disposed in front of the take-out unit 7.

The button product fabricating device 100 further includes a controller 110, a first drive circuit 115, a second drive circuit 116, a third drive circuit 117, a fourth drive circuit 118, a fifth drive circuit 119, a sixth drive circuit 120, and a seventh drive circuit 150, as illustrated in FIG. 3. The controller 110 includes an interface 111, a calculation unit 112, and a storage unit 113. The interface 111 receives, as print data, various data such as image data from an external device 114 such as a computer, a camera, a communication network, a recording medium, a display, and a printer. The controller 110 may be implemented by a single device, or may have a configuration in which a plurality of devices are arranged in a distributed manner and cooperate with one another to operate the button product fabricating device 100.

The storage unit 113 is a memory accessible from the calculation unit 112, and includes a RAM and a ROM. The RAM temporarily stores various data including data received from the external device 114 such as image data, data converted by the calculation unit 112, and the like. The ROM stores a button product fabricating program for performing various processes, predetermined data, and the like. The button product fabricating program may be stored in an external storage medium that is different from the storage unit 113 and that is accessible from the calculation unit 112, such as a CD-ROM.

The calculation unit 112 includes at least one circuit, for example, a processor such as a CPU, and an integrated circuit such as an ASIC. The calculation unit 112 controls each unit by executing the button product fabricating program.

The controller 110 outputs a control signal to the first drive circuit 115. The first drive circuit 115 generates a drive signal based on the control signal and outputs the drive signal to the ejection head 10 of the printing unit 1. The ejection head 10 is driven in accordance with the drive signal, which causes ink droplets to be ejected from a nozzle. Specifically, the first drive circuit 115 causes the ink droplets to be ejected from the ejection head 10 onto the printing medium W while moving the ejection head 10 in a predetermined movement direction based on the image data acquired from the external device 114. Then, the first drive circuit 115 drives the conveying motor 11 to convey the printing medium W in a conveying direction (not illustrated). In this way, the first drive circuit 115 alternately repeats a printing pass and a conveying operation, so that an image based on the image data is printed on the printing medium W.

The controller 110 outputs a control signal to the second drive circuit 116. The second drive circuit 116 generates a drive signal based on the control signal and controls an operation of a conveying motor 23 provided in the conveying unit 2. In this case, the second drive circuit 116 controls the operation of the conveying motor 23 based on a detection result of a later-described first conveying sensor S1 provided in the conveying unit 2. Accordingly, the printing medium W and the white film F from the printing unit 1 are conveyed to the lower die 30 by the conveying unit 2.

The controller 110 outputs a control signal to the third drive circuit 117. The third drive circuit 117 generates a drive signal based on the control signal and controls operations of the upper die lifting motor 34 and the lower die moving motor 140 provided in the die unit 3. In addition, the controller 110 outputs a control signal to the fourth drive circuit 118. The fourth drive circuit 118 generates a drive signal based on the control signal and controls the operation of the pusher motor 46 provided in the front member feeding unit 4. Further, the controller 110 outputs a control signal to the fifth drive circuit 119. The fifth drive circuit 119 generates a drive signal based on the control signal and controls the operation of the pusher motor 56 provided in the back member feeding unit 5. In addition, the controller 110 outputs a control signal to the sixth drive circuit 120. The sixth drive circuit 120 generates a drive signal based on the control signal and controls the operation of the pressing motor 60 provided in the pressing unit 6. In addition, the controller 110 outputs a control signal to the seventh drive circuit 150. The seventh drive circuit 150 generates a drive signal based on the control signal and controls the operation of the take-out motor 70 provided in the take-out unit 7.

### (Front Member and Back Member)

FIG. 4A is a perspective view illustrating the front member SE. FIG. 4B is a perspective view of the back member BE as viewed from a front side. FIG. 4C is a perspective view of the back member BE as viewed from a back side.

As illustrated in FIG. 4A, the front member SE is provided in the button member CE constituting the button product 200 together with the printing medium W. The front member SE has a front member body SEb having, for example, a circular shape in a plan view, and a peripheral edge portion SEa provided on a peripheral edge of the front member body SEb and protruding downward. The front member SE is formed of a magnetic material such as a tin-plated steel plate.

As illustrated in FIG. 4B, the back member BE is provided in the button member CE constituting the button product 200 together with the front member SE. The back member BE has a back member body BEb having, for example, a circular shape in a plan view, and a peripheral edge portion BEa provided on a peripheral edge of the back member body BEb and protruding upward. The back member BE is formed of a magnetic material such as a tin-plated steel plate. The back member body BEb is provided with two holes BEb1 spaced apart from each other in a radial direction.

As illustrated in FIGS. 4B and 4C, a safety pin 150 is provided on a back side of the back member body BEb. The safety pin 150 includes a pin body 151, protruding portions 151a coupled to the pin body 151 and spaced apart from each other in the radial direction of the back member body BEb, and a coupling portion 152. The protruding portions 151a of the safety pin 150 are inserted into the respective holes BEb1 to protrude to a front side of the back member body BEb. The coupling portion 152 couples one protruding portion 151a and the other protruding portion 151a on the front side of the back member body BEb. With the above configuration, the safety pin 150 is attached to the back member BE.

Here, a fixing jig 155 is detachably provided on the back member BE. The fixing jig 155 has supported portions 156 and 157 spaced apart from each other in the radial direction. The supported portion 156 has walls 156a and 156b spaced apart from each other in the radial direction. The wall 156b is disposed at a position closer to the supported portion 157 than the wall 156a. A height of the wall 156a is larger than a height of the wall 156b. The pin body 151 is disposed between the wall 156a and the wall 156b. The pin body 151 is supported in a state of being erected from the wall 156a and the wall 156b. The wall 156a of the supported portion 156 and the supported portion 157 are supported by the back member body BEb of the back member BE, which is located below the back member BE provided with the wall 156a of the supported portion 156 and the supported portion 157, when being stacked and accommodated in the back member feeding unit 5 in the up-down direction Dz. Accordingly, it is possible to avoid interference between the stacked one back member BE and the other back member BE, and thus it is possible to prevent occurrence of damage due to contact between the back members BE. After the button product 200 is fabricated, the user can pivot the supported portion 157 upward while gripping the supported portion 157, thereby releasing the support of the pin body 151 by the supported portion 156. Accordingly, the fixing jig 155 can be detached from the back member BE.

### (Printing Medium and White Film)

Next, the printing medium W and the white film F conveyed from the printing unit 1 toward the lower die 30 by the conveying unit 2 will be described. FIG. 5A is a plan view illustrating the printing medium W, and FIG. 5B is a plan view illustrating the white film F.

The printing medium W constitutes the button product 200 together with the front member SE and the back member BE as the button member CE, and is, for example, a transparent sheet. As illustrated in FIG. 5A, the printing medium W has a rectangular shape. The printing medium W has one end We1 in a direction D1 parallel to the conveying direction Dc1 when being conveyed toward the die unit 3 by the conveying unit 2, and the other end We2 opposite to the one end We1.

The printing medium W includes the sheet-shaped connected portion Wb connected to the front member SE and the back member BE by the die unit 3, a sheet-shaped remaining portion Wa different from the connected portion Wb, and a plurality of coupling portions Wc coupling the connected portion Wb and the remaining portion Wa. The remaining portion Wa surrounds the connected portion Wb. Accordingly, the remaining portion Wa has the one end We1 and the other end We2 in the direction D1. The printing medium W includes the plurality of coupling portions Wc and cut portions Wf each located between the adjacent coupling portions Wc, at a boundary between the connected portion Wb and the remaining portion Wa. Accordingly, the connected portion Wb and the remaining portion Wa are cut and not coupled between the adjacent coupling portions Wc. The connected portion Wb has, for example, a circular shape in a plan view and is located closer to the one end We1 than to the other end We2. That is, the connected portion Wb is unevenly distributed toward the one end We1 with respect to the remaining portion Wa. The connected portion Wb has the same size as the connected portion Fb or a size larger than that of the connected portion Fb.

The printing medium W further includes a linear weak portion Wd extending from an edge portion Wh on the one end We1 to the connected portion Wb. The coupling portion Wc and the linear weak portion Wd form a weak portion having a strength lower than those of the connected portion Wb and the remaining portion Wa. Specifically, it is exemplified that the linear weak portion Wd and a combination of the coupling portion Wc and the cut portion Wf are formed by perforations having the same thickness as the connected portion Wb and the remaining portion Wa but are partially cut. As another example, the coupling portion Wc and the linear weak portion Wd are recesses or the like having a thickness thinner than those of the connected portion Wb and the remaining portion Wa.

The coupling portion Wc includes coupling portions Wc1, coupling portions Wc2, and coupling portions Wc3. The coupling portions We1 couple the connected portion Wb and the remaining portion Wa at a predetermined position Pw1 on the boundary between the connected portion Wb and the remaining portion Wa. The coupling portions Wc2 couple the connected portion Wb and the remaining portion Wa at a position Pw2 on the boundary different from the position Pw1. The coupling portions Wc3 couple the connected portion Wb and the remaining portion Wa at a position Pw3 on the boundary different from the positions Pw1 and Pw2.

The coupling portions Wc are provided at the predetermined position Pw3 on the boundary between the connected portion Wb and the remaining portion Wa more than the positions Pw1 and Pw2. That is, the number of the coupling portions Wc3 is larger than the total number of the coupling portions Wc1 and the coupling portions Wc2. The two coupling portions Wc present on a straight line orthogonal to the conveying direction Dc1 and passing through a center Cw of the connected portion Wb may be included in the coupling portions Wc1 and the coupling portions Wc2, or may be included in the coupling portions Wc3.

A configuration of the white film F is basically the same as the configuration of the printing medium W. Similar to the printing medium W, the white film F constitutes the button product 200 together with the front member SE and the back member BE as the button member CE. As illustrated in FIG. 5B, the white film F has a rectangular shape. The white film F has one end Fe1 in the direction D1 and the other end Fe2 on a side opposite to the one end Fe1.

The white film F includes a sheet-shaped connected portion Fb connected to the front member SE and the back member BE by the die unit 3, a sheet-shaped remaining portion Fa different from the connected portion Fb, and a plurality of coupling portions Fc coupling the connected portion Fb and the remaining portion Fa. The remaining portion Fa surrounds the connected portion Fb. Accordingly, the remaining portion Fa has the one end Fe1 and the other end Fe2 in the direction D1. The white film F includes the plurality of coupling portions Fc and cut portions Ff each located between the adjacent coupling portions Fc, at a boundary between the connected portion Fb and the remaining portion Fa. Accordingly, the connected portion Fb and the remaining portion Fa are cut and not coupled between the adjacent coupling portions Fc. The connected portion Fb has, for example, a circular shape in a plan view and is located closer to the one end Fe1 than to the other end Fe2. That is, the connected portion Fb is unevenly distributed toward the one end Fe1 with respect to the remaining portion Fa.

The white film F further includes a linear weak portion Fd extending from the one end Fe1 to the connected portion Fb. The coupling portion Fc and the linear weak portion Fd form a weak portion having a strength lower than those of the connected portion Fb and the remaining portion Fa. Specifically, it is exemplified that the linear weak portion Fd and a combination of the coupling portion Fc and the cut portion Ff are formed by perforations having the same thickness as the connected portion Fb and the remaining portion Fa but are partially cut. As another example, the coupling portion Fc and the linear weak portion Fd are recesses or the like having a thickness thinner than those of the connected portion Fb and the remaining portion Fa.

The coupling portion Fc includes coupling portions Fc1, coupling portions Fc2, and coupling portions Fc3. The coupling portions Fc1 couple the connected portion Fb and the remaining portion Fa at a position Pf1 on a boundary between the connected portion Fb and the remaining portion Fa and corresponding to the position Pw1. The coupling portions Fc2 couple the connected portion Fb and the remaining portion Fa at a position Pf2 on the boundary and corresponding to the position Pw2. The coupling portions Fc3 couple the connected portion Fb and the remaining portion Fa at a position Pf3 on the boundary and corresponding to the position Pw3.

The coupling portions Fc are provided at the predetermined position Pf3 on the boundary between the connected portion Fb and the remaining portion Fa more than the positions Pf1 and Pf2. That is, the number of the coupling portions Fc3 is larger than the total number of the coupling portions Fc1 and the coupling portions Fc2. The two coupling portions Fc present on a straight line orthogonal to the conveying direction Dc1 and passing through a center Cf of the connected portion Fb may be included in the coupling portions Fc1 and the coupling portions Fc2, or may be included in the coupling portions Fc3.

After the white film F is previously conveyed onto the front member SE by the conveying unit 2, the connected portion Fb of the white film F is pressed against the lower die 30 by the pressing unit 6. Then, the white film Fis conveyed in the conveying direction Dc2 which is a direction opposite to the conveying direction Dc1 by the conveying unit 2 in a state in which the connected portion Fb is pressed. By such a first separation process, only the connected portion Fb is disposed on the front member SE, and the remaining portion Fa is conveyed to and collected in the collection box 8 after being separated from the connected portion Fb. The same applies to the printing medium W. That is, after the printing medium W is subsequently conveyed by the conveying unit 2 onto the connected portion Fb disposed on the front member SE as described above, the connected portion Wb of the printing medium W is pressed against the lower die 30 by the pressing unit 6. Then, the printing medium W is conveyed in the conveying direction Dc2 by the conveying unit 2 in a state in which the connected portion Wb is pressed. By such a second separation process, only the connected portion Wb is disposed on the connected portion Fb on the front member SE, and the remaining portion Wa is conveyed to and collected in the collection box 8 after being separated from the connected portion Wb. By the above processes, the connected portion Fb and the connected portion Wb are disposed in this order on the front member SE.

### (Conveying Unit)

Next, the conveying unit 2 will be described. FIG. 6 is a perspective view illustrating the conveying unit 2. FIG. 7 is a side view of the conveying unit 2 in FIG. 6. FIG. 8 is a perspective view of a one-way clutch CT.

Regarding the conveying unit 2, a part of the conveying unit 2 is disposed in front of the printing unit 1, and the entire conveying unit 2 is disposed in front of the die unit 3. The conveying unit 2 conveys the printing medium W and the white film F conveyed from the printing unit 1 onto the front member SE, which is fed in advance to the lower die 30, along the conveying direction Dc1 toward the die unit 3. In addition, the conveying unit 2 conveys the remaining portion Wa of the printing medium W and the remaining portion Fa of the white film F to the collection box 8 along the conveying direction Dc2. Accordingly, the remaining portion Wa of the printing medium W and the remaining portion Fa of the white film F are collected in the collection box 8 as waste portions. In the present embodiment, a film conveying process is executed in which the white film F is conveyed, prior to the printing medium W, by the conveying unit 2 to be placed on the front member SE held by the lower die 30. Since a conveying method of the printing medium W by the conveying unit 2 is the same as a conveying method of the white film F, the conveyance of the printing medium W will be representatively described later.

As illustrated in FIGS. 6 and 7, the conveying unit 2 includes support plates 20 and 22, a pair of conveying guides 21, the conveying motor 23, plate coupling shafts 24, drive rollers Rk1 to Rk6, the one-way clutches CT, and endless drive belts Be1 to Be6.

The support plates 20 and 22 extend in the up-down direction Dz and are spaced apart from each other in the left-right direction Dy. The support plate 20 and the support plate 22 are coupled by a plurality of plate coupling shafts 24 extending in the left-right direction Dy. The support plate 20 is provided with the conveying guide 21 that curves forward from a lower end rear portion of the support plate 20 and extends upward. The conveying guide 21 is also provided on the support plate 22. The conveying guide 21 includes a first guide body 21a and a second guide body 21b. A groove-shaped space is provided between the first guide body 21a and the second guide body 21b, and end portions of the printing medium W in the left-right direction Dy are inserted into the space during conveyance. The first guide body 21a has a shape being bent or curved forward from the lower end rear portion of the support plate 20 and then being bent or curved rearward while extending upward. The second guide body 21b has a shape being bent or curved forward from the lower end rear portion of the support plate 20 and then extending upward. The first guide body 21a is disposed behind the second guide body 21b as a whole.

The conveying motor 23 is provided on the support plate 22. A drive gear Gal is connected to a rotary shaft of the conveying motor 23. The drive rollers Rk1 to Rk6 are provided on the support plate 22. A drive gear Gb1 is connected to a rotary shaft of the drive roller Rk1. A drive gear Gb2 is connected to a rotary shaft of the drive roller Rk2. A drive gear Gb3 is connected to a rotary shaft of the drive roller Rk3. A drive gear Gb4 is connected to a rotary shaft of the drive roller Rk4. A drive gear Gb5 is connected to a rotary shaft of the drive roller Rk5. A drive gear Gb6 is connected to a rotary shaft of the drive roller Rk6. The drive gears Gb1, Gb2, Gb3, Gb4, and Gb5 are provided on a first conveying path Cp1 to be described later, and the drive gears Gb5 and Gb6 are provided on a second conveying path Cp2 to be described later. The drive gear Gb5 is provided to be shared for both the first conveying path Cp1 and the second conveying path Cp2. Among these drive gears Gb1 to Gb6, the drive gear Gb1, the drive gear Gb2, the drive gear Gb3, and the drive gear Gb6 are provided with the one-way clutches CT in FIG. 8. The one-way clutch CT will be described in detail later.

The drive rollers Rk1 to Rk6 are located to the left of the support plate 22. The drive roller Rk1 is disposed behind and below the drive gear Gal. The drive roller Rk2 is disposed in front of the drive roller Rk1 and behind the drive gear Gal and is disposed above the drive roller Rk1. The drive roller Rk3 is disposed above the drive roller Rk2. The drive roller Rk4 is disposed above the drive roller Rk3. The drive roller Rk5 is disposed behind and above the drive roller Rk4. The drive roller Rk6 is disposed in front of the drive roller Rk5. The drive belt Be1 is stretched around the drive gear Gal and the drive gear Gb1. The drive belt Be2 is stretched around the drive gear Gb1 and the drive gear Gb2. The drive belt Be3 is stretched around the drive gear Gb2 and the drive gear Gb3. The drive belt Be4 is stretched around the drive gear Gb3 and the drive gear Gb4. The drive belt Be5 is stretched around the drive gear Gb4 and the drive gear Gb5. The drive belt Be6 is stretched around the drive gear Gb5 and the drive gear Gb6. With such a configuration, the drive force by the conveying motor 23 is transmitted to the drive gear Gb1, the drive gear Gb2, the drive gear Gb3, the drive gear Gb4, the drive gear Gb5, and the drive gear Gb6 via the drive belts Be1 to Be6.

The first guide body 21a and the second guide body 21b are provided with notches Ng corresponding to the drive rollers Rk2 to Rk4, respectively. The drive roller Rk1 includes a drive shaft Sa1 extending in the left-right direction Dy and a pair of drive-side rollers Ro1. A pair of driven-side rollers Ro2 are provided to face the pair of drive-side rollers Ro1, respectively. Each of the pair of driven-side rollers Ro2 is coupled to a driven shaft Sa2. The drive roller Rk2 includes a drive shaft Sa3 extending in the left-right direction Dy and a pair of drive-side rollers Ro3. A pair of driven-side rollers Ro4 are provided to face the pair of drive-side rollers Ro3, respectively. Each of the pair of driven-side rollers Ro4 is coupled to a driven shaft Sa4. Each of the pair of drive-side rollers Ro3 is disposed in the notch Ng of the second guide body 21b, and each of the pair of driven-side rollers Ro4 is disposed in the notch Ng of the first guide body 21a. Each end portion of the printing medium W in the left-right direction Dy is clamped between the drive-side roller Ro3 and the driven-side roller Ro4. The drive roller Rk5 includes a drive shaft Sa9 extending in the left-right direction Dy and a pair of drive-side rollers Ro9. A pair of driven-side rollers Ro10 are provided to face the pair of drive-side rollers Ro9, respectively. Each of the pair of driven-side rollers Ro10 is coupled to a driven shaft Sa10. A configuration corresponding to the drive roller Rk6 (that is, the pair of drive-side rollers, the pair of driven-side rollers, the drive shaft, and the driven shaft) is the same as the configuration corresponding to the drive roller Rk1, and thus the description thereof will be omitted. In addition, configurations corresponding to the drive rollers Rk3 and Rk4 (that is, the pair of drive-side rollers, the pair of driven-side rollers, the drive shaft, and the driven shaft) are the same as the configuration corresponding to the drive roller Rk2, and thus the description thereof will be omitted.

When the conveying motor 23 is rotationally driven in a predetermined direction, the drive force by the conveying motor 23 is transmitted to the drive gears Gb1 to Gb6. Accordingly, the printing medium Wis conveyed to the lower die 30 along the first conveying path Cp1 to be described later by the rotation of the drive-side rollers Ro1 and the driven-side rollers Ro2, the rotation of the drive-side rollers Ro3 and the driven-side rollers Ro4, the rotation of drive-side rollers Ro5 and driven-side rollers Ro6, the rotation of drive-side rollers Ro7 and driven-side rollers Ro8, and the rotation of the drive-side rollers Ro9 and the driven-side rollers Ro10. The drive-side rollers Ro1 and the driven-side rollers Ro2, the drive-side rollers Ro3 and the driven-side rollers Ro4, the drive-side rollers Ro5 and the driven-side rollers Ro6, the drive-side rollers Ro7 and the driven-side rollers Ro8, and the drive-side rollers Ro9 and the driven-side rollers Ro10 correspond to conveying rollers, respectively. The drive-side rollers Ro9, each of which is a conveying roller constituting a part of the plurality of conveying rollers, are provided to be shared for both the first conveying path Cp1 and the second conveying path Cp2. The drive-side rollers Ro9 convey the printing medium W along the first conveying path Cp1 by the conveying motor 23 being rotationally driven in a normal direction and rotating in the predetermined direction. On the other hand, the drive-side rollers Ro9 convey the printing medium W along the second conveying path Cp2 by the conveying motor 23 being rotationally driven in a reverse direction and rotating in a direction opposite to the predetermined direction.

Here, as illustrated in FIG. 7, a conveying guide piece 25 is disposed, between the support plate 20 and the support plate 22, above the second guide body 21b and in front of the first guide body 21a as a whole. The conveying guide piece 25 has flexibility and is made of, for example, a resin. A base end of the conveying guide piece 25 is fixed to the support plates 20 and 22, and a front end of the conveying guide piece 25 is a free end. The front end of the conveying guide piece 25 faces the first guide body 21a. A distance between the conveying guide piece 25 and the first guide body 21a becomes smaller rearward, that is, toward the lower die 30. The printing medium W is guided toward the drive-side rollers Ro9 and the driven-side rollers Ro10 by the first guide body 21a and the conveying guide piece 25. Thereafter, the printing medium Wis conveyed to the lower die 30 along the conveying direction Dc1 by the drive-side rollers Ro9 and the driven-side rollers Ro10. An upstream end in the conveying direction Dc1 of the printing medium W conveyed to the lower die 30 is in a state of being clamped between the drive-side rollers Ro9 and the driven-side rollers Ro10. As described above, the first guide body 21a, the second guide body 21b, and the conveying guide piece 25 constitute the first conveying path Cp1 of the printing medium W and the white film F toward the lower die 30 of the die unit 3. The first conveying path Cp1 corresponds to a conveying path.

The first conveying sensor S1, which is, for example, a contact sensor, is provided behind the drive-side roller Ro1 and the driven-side roller Ro2. A second conveying sensor S2, which is, for example, a contact sensor, is provided between the first guide body 21a and the conveying guide piece 25. The second drive circuit 116 drives the conveying motor 23 when the printing medium W fed from the printing unit 1 is detected by the first conveying sensor S1. When a downstream end of the printing medium W is detected by the second conveying sensor S2, the second drive circuit 116 controls the driving of the conveying motor 23 based on a rotation amount of the conveying motor 23 by an encoder (not illustrated) immediately after the detection. Accordingly, the printing medium W is conveyed to a predetermined position of the die unit 3 with high accuracy.

A conveying guide 26 and a conveying guide piece 27 are provided between the drive-side rollers Ro9 and the driven-side rollers Ro10, and drive-side rollers Ro11 and driven-side rollers Ro12. The conveying guide 26 is located above the conveying guide piece 27. The conveying guide 26 extends in the front-rear direction Dx. A rear end (that is, an end portion on a lower die 30 side) 26a of the conveying guide 26 is bent upward. Meanwhile, the conveying guide piece 27 has flexibility and is made of, for example, a resin. The conveying guide piece 27 extends in the front-rear direction Dx. A rear end 27a of the conveying guide piece 27 is located in front of the rear end 26a of the conveying guide 26. The rear end 27a of the conveying guide piece 27 is formed to be bent downward. The conveying guide piece 27 intersects the first conveying path Cp1 in a side view illustrated in FIG. 7. With such a configuration, the conveying guide 26 and the conveying guide piece 27 constitute the second conveying path Cp2 of the remaining portions Wa and Fa from the lower die 30 of the die unit 3 toward the collection box 8. In this way, the conveying unit 2 includes the first conveying path Cp1 and the second conveying path Cp2 different from the first conveying path Cp1.

When the printing medium W is conveyed along the first conveying path Cp1, a lower surface of the conveying guide piece 27 is pressed by a downstream-side end portion of the printing medium W and is bent upward. Accordingly, the conveying guide piece 27 allows the conveyance of the printing medium W from the drive-side rollers Ro7 and the driven-side rollers Ro8 to the drive-side rollers Ro9 and the driven-side rollers Ro10. When the printing medium W is conveyed in the conveying direction Dc1 and reaches a predetermined position of the lower die 30, an upstream-side end portion of the printing medium W is in a state of being gripped by the drive-side rollers Ro9 and the driven-side rollers Ro10 and is in a state of being located downstream of the conveying guide piece 27 on the first conveying path Cp1. At this time, the conveying guide piece 27 returns to the state of intersecting the first conveying path Cp1 again due to its flexibility.

The printing medium W conveyed to the predetermined position of the lower die 30 as described above is subjected to a cutting process, by the pressing unit 6, into the connected portion Wb and the remaining portion Wa. Thereafter, a separation process of separating the remaining portion Wa from the connected portion Wb and discarding only the remaining portion Wa along the second conveying path Cp2 is performed. In the separation process, the second drive circuit 116 rotationally drives the conveying motor 23 in a direction opposite to the above predetermined direction in a state in which the connected portion Wb is pressed, by the pressing unit 6, against the front member SE disposed on the lower die 30. Accordingly, the drive force generated due to the reverse rotation of the conveying motor 23 is transmitted to the drive gears Gb1 to Gb6. In this case, as described later, the drive force is not transmitted to the drive-side rollers Ro1, Ro3, and Ro5, and is transmitted to the drive-side rollers Ro7, the drive-side rollers Ro9, and the drive-side rollers Ro11. At this time, when the printing medium W attempts to move toward a downstream side of the second conveying path Cp2, only the remaining portion Wa of the printing medium W is separated from the connected portion Wb due to the connected portion Wb being pressed against the lower die 30 by the pressing unit 6. The remaining portion Wa is conveyed in the conveying direction Dc2 after separation and comes into contact with an outer surface of the conveying guide piece 27 to be guided to the second conveying path Cp2, and is conveyed toward the drive-side rollers Ro11 and the driven-side rollers Ro12. In this case, the rear end 27a of the conveying guide piece 27 is bent downward, and thus the remaining portion Wa is likely to be guided to the second conveying path Cp2. Thereafter, the other end We2 of the remaining portion Wa is clamped and conveyed between the drive-side rollers Ro11 and the driven-side rollers Ro12, and the remaining portion Wa is collected in the collection box 8.

A third conveying sensor S3, which is, for example, a contact sensor, is provided in front of the drive-side roller Ro9 and the driven-side roller Ro10 and behind the drive-side roller Ro11 and the driven-side roller Ro12. It is possible to determine whether the remaining portion Wa is conveyed to the collection box 8 based on a detection result by the third conveying sensor S3. When the remaining portion Wa cannot be detected by the third conveying sensor S3 within a predetermined time after the second drive circuit 116 starts to rotate the conveying motor 23 in a reverse direction, the controller 110 determines that a jam of the remaining portion Wa occurs. In addition, when the remaining portion Wa is still detected after the predetermined time after the remaining portion Wa is detected by the third conveying sensor S3, the controller 110 may determine that a jam of the remaining portion Wa occurs. When it is determined that the jam of the remaining portion Wa occurs, the controller 110 causes the second drive circuit 116 to stop the rotation of the conveying motor 23.

As described above, the drive gear Gb1, the drive gear Gb2, the drive gear Gb3, and the drive gear Gb6 are provided with the one-way clutches CT illustrated in FIG. 8. That is, the one-way clutches CT are provided corresponding to the drive-side rollers Ro1, the drive-side rollers Ro3, and the drive-side rollers Ro5 in the first conveying path Cp1, and are provided corresponding to the drive-side rollers Ro11 in the second conveying path Cp2. As illustrated in FIG. 8, the one-way clutches CT of the drive gear Gb1, the drive gear Gb2, and the drive gear Gb3 transmit the drive force to the drive-side rollers Ro1, Ro3, and Ro5 when rotating in a first rotation direction Dk1, and do not transmit the drive force to the drive-side rollers Ro1, Ro3, and Ro5 when rotating in a second rotation direction Dk2 which is a direction opposite to the first rotation direction Dk1. On the other hand, the one-way clutch CT of the drive gear Gb6 transmits the drive force to the drive-side rollers Ro11 when rotating in the second rotation direction Dk2, and does not transmit the drive force to the drive-side rollers Ro11 when rotating in the first rotation direction Dk1. FIG. 8 illustrates the one-way clutch CT provided on a drive gear Gb that combines the drive gear Gb1, the drive gear Gb2, and the drive gear Gb3. As illustrated in FIG. 8, the one-way clutch CT is press-fitted into a hole of the drive gear Gb along a direction Dct. Accordingly, the drive gear Gb is coupled to the one-way clutch CT. FIG. 8 illustrates a state before the one-way clutch CT is press-fitted into the drive gear Gb.

Various known modes can be adopted as the one-way clutch CT. The one-way clutch CT includes, for example, an outer ring, an inner ring, a plurality of clutch rollers, and a plurality of springs. The clutch roller may be, for example, a needle roller. The one-way clutch CT is formed in a cylindrical shape with the same direction as the direction Det as an axis, and has a through hole h1. A peripheral wall surface of the through hole h1 is an inner peripheral surface of the inner ring. A left end of the drive shaft Sa1 is press-fitted into the through hole h1 of the one-way clutch CT. Accordingly, the one-way clutch CT and the drive shaft Sa1 are coupled to each other. The same applies to the drive shafts Sa3 and Sa5.

The inner ring is provided with a plurality of pockets, and the clutch rollers are disposed in the respective pockets. The clutch rollers are biased toward the outer ring by the springs, so that an inner peripheral surface of the outer ring and the inner ring are indirectly in contact with each other via the clutch rollers. In this configuration, when the drive gear Gb rotates, for example, in the first rotation direction Dk1, a biasing force of the springs is increased, and thus the clutch rollers are strongly pressed against the inner peripheral surface of the outer ring. That is, a contact surface pressure between the inner peripheral surface of the outer ring and the clutch rollers increases. Accordingly, a power of the drive gear Gb is transmitted to the inner ring via the outer ring. Therefore, each of the drive-side rollers coupled to the drive shafts Sa1, Sa3, and Sa5 rotates in the first rotation direction Dk1, and thus the printing medium W is conveyed. On the other hand, when the drive gear Gb rotates, for example, in the second rotation direction Dk2, the biasing force of the springs is decreased, and thus a pressing force of the clutch rollers against the inner peripheral surface of the outer ring is decreased. That is, the contact surface pressure between the inner peripheral surface of the outer ring and the clutch rollers decreases. Accordingly, the power of the drive gear Gb is not transmitted to the inner ring via the outer ring. That is, the inner ring does not rotate, and only the outer ring idles. Therefore, each of the drive-side rollers coupled to the drive shafts Sa1, Sa3, and Sa5 does not rotate, and thus the printing medium W stops in the first conveying path Cp1. A function of the one-way clutch CT on the drive gear Gb6 is opposite to a function of each of the one-way clutches CT on the drive gear Gb1, the drive gear Gb2, and the drive gear Gb3 during rotation in the first rotation direction Dk1 and during rotation in the second rotation direction Dk2.

The one-way clutches CT are provided on the drive gear Gb1, the drive gear Gb2, and the drive gear Gb3 in order to prevent the drive force from being transmitted to the drive-side rollers Ro1, Ro3, and Ro5 when the conveying motor 23 is rotationally driven in the second rotation direction Dk2. While the white film F, which is one sheet to be conveyed first to the lower die 30, is being conveyed along the second conveying path Cp2 in order to execute the separation process of the white film F, the printing medium W, which is another sheet to be conveyed later, is stopped in the first conveying path Cp1 without being conveyed along the first conveying path Cp1 by the one-way clutch CT. Therefore, the printing medium W is not conveyed in a reverse direction during the execution of the separation process. On the other hand, the one-way clutch CT is provided on the drive gear Gb6 in order to prevent the drive force from being transmitted to the drive-side rollers Ro11 when the conveying motor 23 is rotationally driven in the first rotation direction Dk1. Accordingly, it is possible to prevent a force in a direction opposite to a direction toward the second conveying path Cp2 from being applied to the white film F conveyed along the second conveying path Cp2 while the printing medium W is conveyed along the first conveying path Cp1.

Subsequently, a holding position (that is, a waiting position) of the printing medium W in the first conveying path Cp1 will be described. In the present embodiment, a conveying path length of the first conveying path Cp1 is a length of the conveying path from the first conveying sensor S1 (hereinafter, referred to as a reference point) to the downstream end of the printing medium W disposed on the lower die 30. The conveying path length of the first conveying path Cp1 may be equal to or larger than a total value of a total length of the white film F and the printing medium W, which are two sheets, and a conveying interval between the white film F, which is one sheet of the two sheets conveyed first to the lower die 30, and the printing medium W, which is the other sheet conveyed later to the lower die 30.

Specifically, the conveying path length of the first conveying path Cp1 is, for example, 457.4 mm. Specifically, the conveying path length from the first conveying sensor S1 to a nip position (that is, a clamping position) of the drive-side roller Ro1 is, for example, 25 mm. A conveying path length from the nip position of the drive-side roller Ro1 to a nip position of the drive-side roller Ro3 is, for example, 70.4 mm. A conveying path length from the nip position of the drive-side roller Ro3 to a nip position of the drive-side roller Ro5 is, for example, 80 mm. A conveying path length from the nip position of the drive-side roller Ro5 to a nip position of the drive-side roller Ro7 is, for example, 80 mm. A conveying path length from the nip position of the drive-side roller Ro7 to a nip position of the drive-side roller Ro9 is, for example, 91.9 mm. A conveying path length from the nip position of the drive-side roller Ro9 to the downstream end of the printing medium W disposed on the lower die 30 is, for example, 110 mm.

In order to shorten a fabricating time of the button product 200, that is, in order to quickly convey the printing medium W to be conveyed next to the white film F to the lower die 30, a plurality of sheets are held in the first conveying path Cp1. As described above, a configuration in which the printing medium W and the white film F are alternately stacked and held in the sheet holder of the printing unit 1 is adopted, and thus the sheets are the white film F that is conveyed first and the printing medium W that is conveyed later to one front member SE. Hereinafter, at which point in the first conveying path Cp1 the printing medium W conveyed after the white film F is held will be described.

In the following description, it is assumed that the white film F is previously conveyed to the lower die 30. First, when the separation process of the white film F is performed in the second conveying path Cp2, the printing medium W is held such that the downstream end of the printing medium W is located at a position immediately before the drive-side roller Ro7 that is not provided with the one-way clutch CT, from the viewpoint of preventing the printing medium W held in the first conveying path Cp1 from being conveyed in a reverse direction. A conveying path length from the reference point to the position immediately before the drive-side roller Ro7 is, for example, 255 mm. In this regard, if the downstream end of the printing medium W is located upstream of a position on the first conveying path Cp1 having a conveying path length of 255 mm, the printing medium W is not clamped between the drive-side rollers Ro7 (that is, the drive-side rollers coupled to the drive gear Gb4 not provided with the one-way clutch CT) and the driven-side rollers Ro8 facing the drive-side rollers Ro7. In this case, even if the conveying motor 23 is rotated in the reverse direction to perform the above separation process, the drive force thereof is not transmitted to the drive-side rollers Ro1, Ro3, and Ro5. Accordingly, it is possible to prevent the printing medium W held in the first conveying path Cp1 from being conveyed in a reverse direction when the separation process is performed. From the above, in the first conveying path Cp1, it is preferred to hold the printing medium W such that the downstream end of the printing medium W is located at a point at which the conveying path length is 255 mm or less.

However, from the viewpoint of quickly conveying the white film F to be conveyed after the printing medium W held in the first conveying path Cp1, it is desirable that a downstream end of the white film F is clamped between the drive-side rollers Ro1 and the driven-side rollers Ro2. In this case, in order to clamp the downstream end of the white film F between the drive-side rollers Ro1 and the driven-side rollers Ro2, the downstream end of the white film F needs to be conveyed and positioned to a point of, for example, 30 mm larger than 25 mm, which is the conveying path length from the reference point to the drive-side roller Ro1. From the above, in the first conveying path Cp1, the printing medium Wis held such that the downstream end of the printing medium W is located at a point at which the conveying path length is 225 mm (=255 mm−30 mm) or less. Accordingly, even when the white film F is conveyed such that the downstream end of the white film F is positioned at the point of 30 mm, the downstream end of the printing medium W held on a downstream side of the white film F can be held at a point on the first conveying path Cp1 having a conveying path length of 255 mm.

On the other hand, there is a viewpoint of quickly conveying the printing medium W on the first conveying path Cp1 to the lower die 30. In this regard, it is preferred that an upstream end of the printing medium W is positioned downstream of the nip position between the drive-side roller Ro1 and the driven-side roller Ro2. A length of the printing medium W is, for example, 127 mm. In this case, the downstream end of the printing medium W is positioned at a point at which the upstream end of the printing medium W exceeds the nip position between the drive-side roller Ro1 and the driven-side roller Ro2. That is, the downstream end of the printing medium W is positioned at a point of 152 mm obtained by adding a printing medium length (127 mm) to a conveying path length (25 mm) from the first conveying sensor S1 to the nip position of the drive-side roller Ro1.

As described above, in the present embodiment, the printing medium W is held such that the downstream end of the printing medium W is located at a point at which the conveying path length of the first conveying path Cp1 is 152 mm or more and 225 mm or less. Accordingly, even if the white film F to be conveyed after the printing medium W is conveyed by, for example, 30 mm so as to be clamped between the drive-side rollers Ro1 and the driven-side rollers Ro2, the downstream end of the printing medium W can be held at the position immediately before the drive-side roller Ro7. In this way, the first conveying path Cp1 holds a plurality of sheets including the printing medium W (that is, the printing medium W and the white film F). In order to prevent an interval between the printing medium W held in the first conveying path Cp1 and the white film F to be conveyed next from becoming too large, it is desirable to hold the printing medium W such that the downstream end of the printing medium W is located at a point at which the conveying path length of the first conveying path Cp1 is, for example, 200 mm. In this case, an interval between the upstream end of the printing medium W held in the first conveying path Cp1 and the downstream end of the white film F can be set to an appropriate interval (for example, 73 mm (=200 mm−127 mm)).

### (Die Unit)

Next, the die unit 3 will be described. FIG. 9 is a perspective view of the die unit 3. The die unit 3 crimps the front member SE and the back member BE.

The die unit 3 includes the lower die 30, the lower die 31, the lower die moving motor 140, the rotation support table 32, the upper die 33, the upper die lifting motor 34, a first gear 35, a second gear 36, a pair of rotary cams 37, and a support plate 38, as illustrated in FIG. 9.

The die unit 3 includes the lower die 30 which supports the front member SE and the lower die 31 which supports the back member BE as a plurality of dies arranged along a circumferential direction with respect to a rotary shaft. The lower die 30 and the lower die 31 are formed in a circular shape in a plan view. The lower die 30 and the lower die 31 face each other with a center of the rotation support table 32 as a reference, and are supported by the rotation support table 32 via springs 30s, respectively. In an initial stage, the lower die 30 is disposed in front of the lower die 31. The rotation support table 32 has a substantially circular shape in a plan view. A gear 32a is provided on a side peripheral surface of the rotation support table 32 parallel to an axial direction. The lower die moving motor 140 is provided on a lateral side of the rotation support table 32. A gear 131 is connected to a rotary shaft of the lower die moving motor 140. The gear 131 is engaged with the gear 32a of the rotation support table 32. Accordingly, when the lower die moving motor 140 is rotationally driven, a drive force thereof is transmitted to the rotation support table 32 via the gears 131 and 32a. Therefore, the rotation support table 32 pivots in the up-down direction Dz. By pivoting the rotation support table 32 in this way, each of the lower die 30 and the lower die 31 is displaced between the first die position Pm1 and the second die position Pm2 facing the first die position Pm1 in the front-rear direction Dx. The first die position Pm1 is a position at which the front member SE or the back member BE is loaded. The second die position Pm2 is a position at which the front member SE held by the upper die 33 is bonded to the back member BE loaded and supported by the lower die 31. When the lower die 30 is at the first die position Pm1, the lower die 30 receives the front member SE from the front member feeding unit 4. On the other hand, when the lower die 31 is at the first die position Pm1, the lower die 31 receives the back member BE from the back member feeding unit 5.

The support plate 38 is erected on the lateral side of the rotation support table 32. The upper die lifting motor 34 for raising and lowering the upper die 33 is disposed on the support plate 38. A third gear (not illustrated) is connected to a rotary shaft of the upper die lifting motor 34. The third gear is meshed with the first gear 35. The first gear 35 is provided with a fourth gear (not illustrated) coaxially with the first gear 35. The fourth gear is engaged with the second gear 36. The pair of rotary cams 37 are connected to the second gear 36.

The support plate 38 is provided with a plate member 38a extending in the front-rear direction Dx toward above the lower die 31. The upper die 33 is located below the plate member 38a. The upper die 33 includes an inner die 33a and an annular outer die 33b that is provided below the inner die 33a, is coaxially with the inner die 33a, and has an inner diameter larger than an outer diameter of the inner die 33a. The inner die 33a is provided with a pair of pressed members 33c provided below the plate member 38a and extending in the left-right direction Dy. One rotary cam 37a of the pair of rotary cams 37 presses one of the pressed members 33c downward, and the other rotary cam 37b of the pair of rotary cams 37 presses the other pressed member 33c downward. With such a configuration, when the upper die lifting motor 34 is rotationally driven, a drive force thereof is transmitted to the second gear 36 via the third gear, the first gear 35, and the fourth gear. Accordingly, the second gear 36 pivots in a pivot direction Dr2, and the pair of rotary cams 37 also pivot in the pivot direction Dr2 accordingly. At this time, the rotary cam 37a pushes down one of the pressed members 33c, and the rotary cam 37b pushes down the other pressed member 33c, so that the inner die 33a can be slid with respect to the outer die 33b and lowered to the lower die 30 or the lower die 31. The upper die lifting motor 34 can be rotated in a reverse direction to raise the upper die 33 to above the lower dies 30 and 31.

### (Button Product)

FIG. 10 is a cross-sectional view of the button product 200 fabricated by crimping the front member SE and the back member BE. As illustrated in FIG. 10, the front member SE is a member whose peripheral edge portion SEa protrudes downward, and the back member BE is a member whose peripheral edge portion BEa protrudes upward. The button product 200 is formed by crimping the front member SE separated and held by the upper die 33, the connected portion Wb of the printing medium W, and the back member BE. The button product 200 is, for example, a button badge. In a state in which a peripheral edge portion Fg of the connected portion Fb and a peripheral edge portion Wg of the connected portion Wb that are disposed on the front member SE are bent and clamped between the peripheral edge portion SEa and the peripheral edge portion BEa, the peripheral edge portion SEa and the peripheral edge portion BEa are crimped. Accordingly, the button product 200 is fabricated.

### (Conveyance System Time Chart)

Next, a time chart of a process of the printing unit 1, a process of the conveying unit 2, and a process of the die unit 3 will be described. FIG. 11 is a diagram illustrating the time chart related to the process of the printing unit 1, the process of the conveying unit 2, and the process of the die unit 3. In the description in FIG. 11, it is assumed that the same image is printed on the plurality of printing media W by the printing unit 1.

As illustrated in FIG. 11, first, the white film F held by the sheet holder is conveyed in the printing unit 1 (step S1). In synchronization with the process of step S1, the front member SE is fed to the lower die 30 in the die unit 3 (step S2). When the process of step S1 is completed at a time T1, the printing on the printing medium W and the conveyance of the printing medium W are performed in the printing unit 1 (step S3). In this case, the controller 110 acquires a printing time for the first printing medium W, which is the previous printing medium W, from a printing job. Then, in synchronization with the process of step S3, the white film F sent from the printing unit 1 is conveyed in the conveying unit 2 (step S4).

When the process of step S4 is completed at a time T2, that is, when the white film F is conveyed to the lower die 30, a cutting process and a separation process of the white film F by the conveying unit 2 are performed (step S5). As a result of the process of step S5, the connected portion Fb of the white film F is loaded on the front member SE held by the lower die 30 in the die unit 3. Next, the printing medium W sent from the printing unit 1 is conveyed by the conveying unit 2 at a predetermined time T3 after the process of step S5 (step S6). When the process of step S6 is completed at a time T4, the next white film F is conveyed in the printing unit 1 in synchronization with the completion (step S7). In synchronization with the process of step S7, the cutting process and the separation process of the printing medium W by the conveying unit 2 are performed (step S8). As a result of the process of step S8, the connected portion Wb of the printing medium W is loaded on the connected portion Fb disposed on the front member SE held by the lower die 30 in the die unit 3.

Here, the controller 110 determines a timing of starting printing on the subsequent printing medium W in accordance with the acquired printing time and a time required for the die unit 3 to connect the front member SE and the back member BE on which the first printing medium W is disposed, and stores the timing in the storage unit 113. As a specific example, the controller 110 determines the timing in accordance with the printing time and a time T5 at which the connected portion Wb is loaded on the connected portion Fb on the front member SE as described above in the die unit 3, that is, the time T5 at which the process of step S8 is completed, and stores information related to the timing in the storage unit 113.

When the process of step S8 is completed at the time T5, the printing on the next printing medium W and the conveyance of the printing medium W are performed in the printing unit 1 (step S9). In this case, the controller 110 reads the information related to the timing from the storage unit 113 and outputs the information to the first drive circuit 115. Then, in synchronization with the process of step S9, the rotation support table 32 is rotated in the die unit 3 (step S10). Accordingly, the lower die 30 which supports the front member SE on which the connected portion Fb and the connected portion Wb are disposed moves from the first die position Pm1 to the second die position Pm2, and the lower die 31 at the second die position Pm2 moves to the first die position Pm1. The subsequent process is as described above, and thus the description thereof will be omitted.

As described above, according to the button product fabricating device 100 in the present embodiment, the printing medium W is conveyed by the conveying unit 2 onto the front member SE supported by the lower die 30. Accordingly, a time required for disposing the printing medium W on the front member SE is shortened, and thus the fabricating time of the button product 200 can be shortened as a whole. In addition, the conveying unit 2 includes the one-way clutches CT, the sheet in the first conveying path Cp1 can be stopped in the first conveying path Cp1 during the separation process using the second conveying path Cp2. Accordingly, it is possible to prevent the sheet in the first conveying path Cp from being conveyed in a reverse direction.

In the present embodiment, the first conveying path Cp1 holds the plurality of sheets, and thus the sheets can be quickly conveyed from the first conveying path Cp1 to the lower die 30 in accordance with the connection between the front member SE and the back member BE in the die unit 3.

In the present embodiment, the conveying path length of the first conveying path Cp1 may be equal to or larger than the total value of the total length of the white film F and the printing medium W and the conveying interval between the white film F and the printing medium W. Accordingly, the plurality of sheets can be held in the first conveying path Cp1 while ensuring an appropriate conveying interval.

In the present embodiment, while the white film F that is conveyed first to the lower die 30 is being conveyed along the second conveying path Cp2 in order to execute the separation process of the white film F, the printing medium W that is conveyed later is stopped in the first conveying path Cp1 by the one-way clutch CT. Accordingly, it is possible to prevent the printing medium W in the first conveying path Cp1 from being conveyed in a reverse direction during the separation process. In addition, by causing the printing medium W to stop (that is, wait) in the first conveying path in this way, the printing medium W can be quickly conveyed to the lower die 30 of the die unit 3.

Further, in the present embodiment, when the same image is printed on the plurality of printing media W, the controller 110 determines the timing of starting printing on the subsequent printing medium W in accordance with the printing time for the first printing medium W and a time at which the connected portion Wb is loaded on the connected portion Fb on the front member SE in the die unit 3. Accordingly, the printing on the subsequent printing medium W can be executed at an appropriate timing, which contributes to the shortening of a total printing time (sum of the printing time for each printing medium W).

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Modifications

The present disclosure is not limited to the above embodiment, and modifications can be adopted without departing from the gist of the present disclosure. For example, the present disclosure is modified as follows.

In the above embodiment, the conveying unit 2 may set the printing time for the printing medium W shorter when a printing range on the printing medium W is less than a predetermined value than when the printing range on the printing medium W is equal to or larger than the predetermined value. In this case, the controller 110 acquires information related to the printing range on the printing medium W from the printing job, and outputs a control signal based on a comparison between the information and a predetermined value stored in advance in the storage unit 113 to the first drive circuit 115. The first drive circuit 115 generates a drive signal based on the control signal and outputs the drive signal to the ejection head 10. The ejection head 10 is driven in accordance with the drive signal, whereby the ink droplets are ejected from the nozzle onto the printing medium W.

As described above, the printing time for the printing medium W in the printing unit 1 may be shortened. In this case, the next sheet cannot be conveyed to the lower die 30 by the conveying unit 2 unless the connection between the front member SE and the back member BE by the die unit 3 is completed, and thus there is a possibility that the plurality of sheets overlap in the conveying unit 2 and cannot be conveyed. Therefore, when the printing range on the printing medium W is less than the predetermined value, the printing unit 1 may perform an image addition process of additionally printing an image on the printing medium W in accordance with the time required for the die unit 3 to connect the front member SE and the back member BE. Specifically, as illustrated in FIG. 12, for example, a circular image Gp can be additionally printed in a region inside the cut portion Wf and outside an image printing region (that is, a printing region when no image addition process is performed) Rg in the connected portion Wb of the printing medium W. Accordingly, it is possible to make the printing time when the printing range on the printing medium W is less than the predetermined value substantially the same as the printing time when the printing range on the printing medium W is equal to or larger than the predetermined value. Therefore, the printing time can be always kept substantially constant regardless of a size of the printing range on the printing medium W, and thus it is possible to reduce the possibility that the plurality of sheets overlap in the conveying unit 2 and cannot be conveyed. The region in which the image Gp is printed is not limited to the above.

In the above embodiment, a part of the conveying unit 2 is disposed in front of the printing unit 1, but the present disclosure is not limited thereto. A part of the conveying unit 2 may be disposed on the lateral side of the printing unit 1, and a part of the conveying unit 2 may be disposed, for example, to the left, right, or rear of the printing unit 1.

In the above embodiment, the drive gear Gb4 is not provided with the one-way clutch CT, but the present disclosure is not limited thereto, and the drive gear Gb4 may be provided with the one-way clutch CT. However, when the drive gear Gb4 is not provided with the one-way clutch CT, a cost can be reduced.

In the above embodiment, each of the lower die 30 and the lower die 31 is displaced between the first die position Pm1 and the second die position Pm2 by pivoting the rotation support table 32. However, the present disclosure is not limited thereto. It is also possible to adopt a slide mechanism that displaces each of the lower die 30 and the lower die 31 between the first die position Pm1 and the second die position Pm2, for example, in a sliding manner.

In the above embodiment, the front member SE and the back member BE each have a circular shape in a plan view, but the present disclosure is not limited thereto, and the front member SE and the back member BE may have another shape such as an elliptical shape.

In the above embodiment, the connected portion Wb of the printing medium W has a circular shape in a plan view, but the present disclosure is not limited thereto, and the connected portion Wb may have another shape such as an elliptical shape.

In the above embodiment, a marker may be disposed in the remaining portion Wa of the printing medium W on one side in a direction D2 orthogonal to the direction D1 with a center in the direction D2 as a reference. Accordingly, when the user accommodates the printing medium W in the sheet holder of the printing unit 1, the front and back and the arrangement orientation of the printing medium W are less likely to be wrong.

What is claimed is:

1. A button product fabricating device configured to fabricate a button product by connecting a front member and a back member, the button product fabricating device comprising:
a printer configured to perform printing on a printing medium;
a die set configured to connect the front member and the back member; and
a conveyor configured to convey the printing medium onto the front member along a conveying path from the printer toward the die set,
wherein the conveyor comprises: a plurality of conveying rollers; and a one-way clutch, the one-way clutch being configured to: transmit a drive force to the conveying rollers when rotating in a first rotation direction; and not to transmit the drive force to the conveying rollers when rotating in a second rotation direction which is a direction opposite to the first rotation direction.

2. The button product fabricating device according to claim 1,
wherein the conveying path is configured to hold a plurality of printing media including the printing medium.

3. The button product fabricating device according to claim 2,
wherein a length of the conveying path is equal to or larger than a total value of a total length of two of the plurality of printing media and a conveying interval between one of the two of the plurality of printing media and another of the two of the plurality of printing media.

4. The button product fabricating device according to claim 2,
wherein the conveying path is a first conveying path, and the button product fabricating device further comprises a second conveying path different from the first conveying path,
wherein the plurality of conveying rollers comprise at least one first conveying roller and at least one second conveying roller, the at least one second conveying roller being provided in the first conveying path and different from the first conveying roller,
wherein the at least one first conveying roller is provided to be shared for both the first conveying path and the second conveying path, the at least one first conveying roller being configured to convey the plurality of printing media along the first conveying path when rotating in a predetermined direction, and convey the plurality of printing media along the second conveying path when rotating in a direction opposite to the predetermined direction,
wherein the one-way clutch is provided so as to correspond to the at least one second conveying roller, and
wherein while one of the plurality of printing media is conveyed in the second conveying path, another of the plurality of printing media is stopped in the first conveying path without being conveyed in the first conveying path by the one-way clutch.

5. The button product fabricating device according to claim 1, further comprising:
a controller,
wherein the controller is configured to, in a case in which a same image is to be printed on a plurality of printing media, acquire a printing time for a previous printing medium from a printing job, and determine a timing of starting printing on a subsequent printing medium in accordance with the printing time and a time required for the die set to connect the front member and the back member on which the previous printing medium is disposed.

6. The button product fabricating device according to claim 1,
wherein the conveyor is configured to set a printing time for the printing medium shorter in a case in which a printing range on the printing medium is less than a predetermined value than in a case in which the printing range on the printing medium is equal to or larger than the predetermined value.

7. The button product fabricating device according to claim 1,
wherein the printer is configured to, in a case in which a printing range on the printing medium is less than a predetermined value, add an image to be printed on the printing medium in accordance with a time required for the die set to connect the front member and the back member.
